(19) United States
(12) Patent Application Publication
(10) Pub. No.: US 2026/0282149 A1
(43) Pub. Date: Sep. 17, 2026

(54) USER EQUIPMENT TIME SYNCHRONIZATION UPDATE IN RRC_INACTIVE

(71) Applicant: APPLE INC., Cupertino, CA (US)

(72) Inventors: Ralf Rossbach, Munich (DE); Naveen Kumar R Palle Venkata, San Diego, CA (US); Haijing Hu, Los Gatos, CA (US); Ping-Heng Kuo, London (GB); Alexander Sirotkin, Hod Hasharon (IL); Fangli Xu, Beijing (CN); Zhibin Wu, Los Altos, CA (US); Peng Cheng, Beijing (CN); Yuqin Chen, Beijing (CN)

(21) Appl. No.: 19/167,235

(22) PCT Filed: Apr. 24, 2023
(86) PCT No.: PCT/CN2023/090175

§ 371 Date: Sep. 19, 2025

(51) Int. Cl. H04W 76/20; H04W 56/00; H04W 68/02; H04W 76/19

(52) U.S. Cl. CPC H04W 76/20; H04W 56/0015; H04W 68/02; H04W 76/19

(57) ABSTRACT

Embodiments herein may allow a user equipment (UE) to receive clock quality information while in a radio resource control (RRC) inactive state. The UE may receive an indication of a time synchronization status change from a network node while in the RRC inactive state. The UE may send an uplink small data transmission (SDT) message to the network node to request updated clock quality information while in the RRC inactive state. The UE may receive a downlink SDT message from the network node while in the RRC inactive state. The downlink SDT message comprises the updated clock quality information.

### TECHNICAL FIELD

This application relates generally to wireless communication systems, including wireless communication systems designed for enhanced timing resiliency.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB). Another example of an NG_RAN base station is a next generation eNB (ng-eNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a 5G timing resiliency system, according to embodiments discussed herein.

FIG. 2 illustrates objectives for NR timing resiliency and URLLC enhancements in as may be understood in some wireless communications systems.

FIG. 3 illustrates a 5GS, according to embodiments discussed herein.

FIG. 4 illustrates a signal flow diagram of a mobile originated (MO) random access (RA) SDT for an update for time synchronization in accordance with some embodiments.

FIG. 5 illustrates a signal flow diagram of a mobile terminated (MT) RA-SDT for an update for time synchronization in accordance with some embodiments.

FIG. 6 illustrates a flowchart of a method 600 of a UE, according to embodiments herein.

FIG. 7 illustrates a flowchart of a method 700 of a network node, according to embodiments herein.

FIG. 8 illustrates an example architecture of a wireless communication system, according to embodiments disclosed herein.

FIG. 9 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

For example, a 5G system (5GS) may use a local GNSS server, and/or may be time synchronized with an external clock using transport network synchronization protocols, etc. In some 5GSs, a 5G Grand Master (GM) clock and/or a synchronization plane of the 5G network (for RAN and CN) may have different time/frequency sources (such as a GNSS signal, Synchronous Ethernet (Sync E), PTP transport network, PPS input, etc.).

In some wireless communication systems, timing resiliency and/or ultra-reliable low latency communications (URLLC) enhancements may include enabling the system (e.g., a 5G system (5GS)) to use a backup for/alternative mechanism from a current time distribution source.

For example, there may be requirement(s) for a 5GS to remain time resilient after a GNSS failure and to act as a backup and offer wireless and/or indoor-capable time synchronization service for other applications (e.g. financial applications, power grid systems applications, factory use-case applications, etc.).

For example, see 3GPP Technical Specification (TS) 22.261, version 19.2.0, clause 6.36 (March 2023), where work was preceded by a study in 3GPP Technical Report (TR) 22.878, version 18.2.0 (December 2021). Note also that another completed study on “5G Timing Resiliency and TSC & URLLC enhancements” (FS_5TRS_URLLC) is captured in 3GPP TR 23.700-25, version 18.1.0 (March 2023), which discusses a key issue (KI) with relevance to disclosure herein as KI #1: 5GS network timing synchronization status and reporting.

Note that while many examples for a backup/alternative mechanism given discussed herein are provided in the context of a failure of GNSS-based time distribution source, it will nevertheless be understood that such methodologies could be analogously provided in cases of a failure of another type of time distribution source (other than GNSS) that is currently being used.

Further, it may be beneficial to support/meet various timing resiliency requirements, such as a reporting of a network timing synchronization status (such as divergence from universal time coordinated (UTC) and/or network timing source degradation) to UEs and/or 3rd party application functions (AFs), to support the ability for a RAN and/or a core network (e.g., a 5GC) to determine/learn about a network timing synchronization status and to be able to inform UEs and AFs regarding the network timing synchronization status, and/or to support the provision of a timing synchronization status to UEs and AFs.

For example, see a work item on Timing Resiliency and URLLC Enhancements (TRS_URLLC), 3GPP Technical Specification Group (TSG) Services and System Aspects (SA) Meeting #SP-99, SP-230107 (Mar. 21-24, 2023).

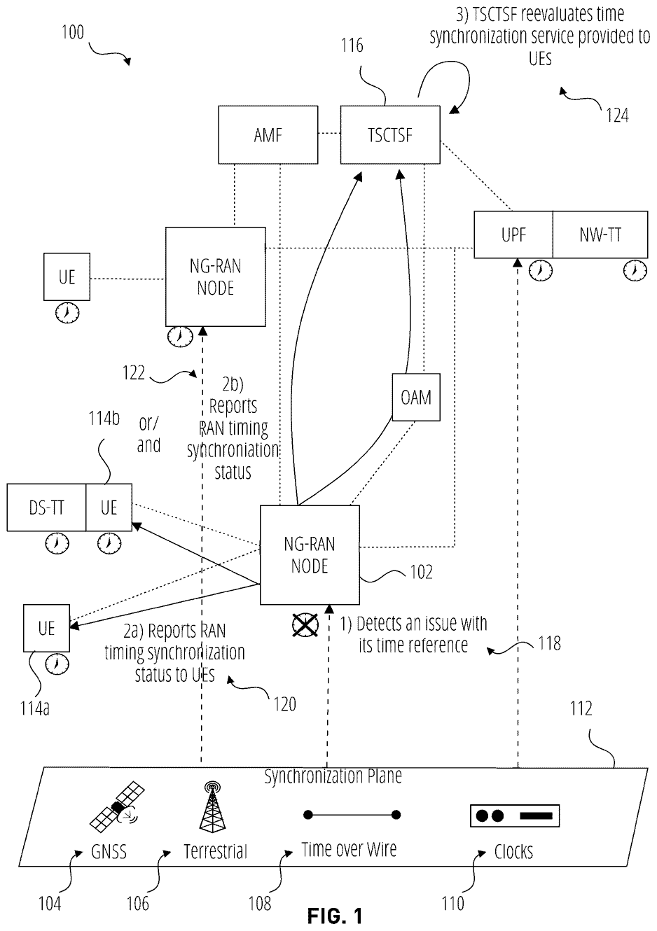

FIG. 1 illustrates a 5G timing resiliency system 100, according to embodiments discussed herein. The 5G timing resiliency system 100 may include, among other things, an NG-RAN node 102 taking timing information from one or more of a GNSS source 104, a terrestrial source 106, a time over wire source 108, and/or a clock source 110 of a synchronization plane 112, one or more UE(s) 114a and 114b, and a Time Sensitive Communication Time Synchronization Function (TSCTSF) 116.

The NG-RAN node 102 may first detect 118 an issue with its time reference (e.g., the one or more timing sources from the synchronization plane 112 that is being used). In response, the NG-RAN node 102 may report 120 an updated RAN timing synchronization status (e.g., that reflects the issue with the time reference) to one or more UE(s) 114a, 114b. Additionally or alternatively, the NG-RAN node 102 may report 122 such an updated RAN timing synchronization status to the TSCTSF 116. The TSCTSF 116 thereby enabled to reevaluate 124 time synchronization-dependent service(s) provided to one or more of the UE(s) 114a, 114b. See also 3GPP TSG RAN Meeting #99, RP-230086 (Mar. 20-23, 2023).

Some 5G networks rely on GNSS for establishing timing. Accordingly, for example, GNSS modules may be integrated at radio sites, or a GM may reside internally or externally to the 5GS, and/or timing information may be distributed within an operator's transport network via Precision Time Protocol (PTP) or other GM solutions. Timing resiliency enhancements may be used within such networks to improve a robustness of time-of-day services provided by 5G in cases of GNSS degradation/failure. Such enhancements may assist the end user in determining a preferred time source. Note that timing resiliency enhancements implemented in the 5GS may be accordingly seen as either a supplement or an alternative to the use of GNSS as a time provider.

Use cases for such timing resiliency enhancements may be found in both 5G public network customer (e.g., smart grid services, financial services) and 5G private network customer (e.g., factory use cases) contexts. Other use cases may include audio video production (AVprod, as described in 3GPP TS 22.104, version 17.3.0, annex E (July 2020); video, imaging and audio for professional applications (VIAPA), as described in 3GPP TS 22.263, version 17.4.0 (July 2021); and/or Programme Making and Special Events (PMSE), as described in 3GPP TR 22.804, version 16.3.0, section 5.8 (July 2020).

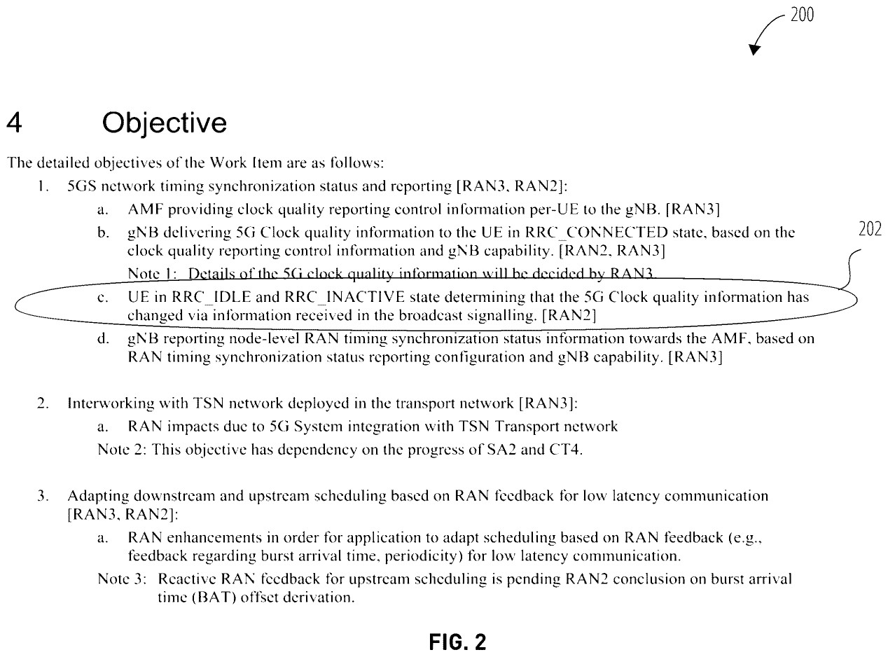

In connection with this setting, it may be beneficial to evaluate RAN impacts. FIG. 2 illustrates objectives 200 for NR timing resiliency and URLLC enhancements as may be understood in the context of various wireless communications systems. See 3GPP TSG RAN Meeting #99, RP-230754 (Mar. 20-23, 2023).

As illustrated, one objective 202 for 5GS network timing synchronization status and reporting may be to enable a UE in a radio resource control (RRC) idle (RRC_IDLE) state or an RRC inactive (RRC_INACTIVE) state to determine that applicable 5G clock quality information has changed via information received in broadcast signaling.

With respect to 5GS network timing synchronization status and reporting, it may be that UEs in RRC INACTIVE or RRC_IDLE states receive an indication of a time synchronization status change via system information block (SIB) broadcast signaling (e.g., in an SIB 9). See 3GPP TR 23.700-25. In such cases, to retrieve/receive an accurate (and complete) time status and/or updated clock quality information, the UE may need to enter an RRC connected (RRC_CONNECTED) state, after which the gNB/base station may send time information to the UE using unicast signaling. In the RRC_CONNECTED state, it is also possible for the network to compensate for over the air propagation delay and/or to direct the UE to cells that offer the best possible time accuracy.

It may be noted that for UEs that are already in an RRC_CONNECTED state, the network can deliver updated clock quality information via dedicated signaling without the need for an RRC state change at the UE.

Details regarding the indication from the NG-RAN to the UEs of the time synchronization status change via SIB 9 are now provided. When a network timing synchronization status exceeds a threshold (which is indicative of a problematic timing status), the NG-RAN may include a reference report ID in a broadcast SIB 9. When the network timing synchronization status later meets/returns within the thresholds (e.g., a timing status improvement occurs), the NG-RAN may stop broadcasting that reference report ID in the SIB 9. In such circumstances, either event (the new use or the discontinued use of the reference report ID in SIB 9) serves as a notification for the UEs reading the SIB 9 that new clock quality information is available.

In such cases, a UE in an RRC_INACTIVE state or an RRC_IDLE state compares the reference report ID (or lack of the reference report ID) in SIB 9 with a locally stored reference report ID/reference report ID status (e.g., from/corresponding to a prior SIB 9) to determine if that UE already has the last available clock quality information. Note that in some embodiments, a reference report ID consists of a scope of the report ID and/or an event ID integer. In some cases, the indicated scope is used to support providing clock quality for all the cells within a single NG-RAN node.

If the UE is instructed by the Access and Mobility Management Function (AMF) (e.g., via a registration or a UE configuration update procedure) to reconnect to the network in cases when the UE determines that report ID has changed, the UE will leave the RRC INACTIVE state or the RRC_IDLE state (as the case may be) and reconnect to the network (enter into an RRC_CONNECTED state). After the UE has reconnected to the network, the NG-RAN may use unicast RRC signaling to provision (updated) clock quality information to the UE.

Note that various 5GS network timing synchronization status and reporting-related conclusions may be found in 3GPP TSG SA Meeting #SP-98-e, SP-230066 (Mar. 21-24, 2023). Further, additional detail on the support of network timing synchronization status and reporting can be found in 3GPP TSG Core Network and Terminals (TSG-CT) Working Group 1 (WG 1) Meeting #133-e, Change Request (CR) 3807 for TS 23.501 (Nov. 11-19, 2021) and 3GPP TSG-SA Working Group 2 (SA2) Meeting #155, CR 3892 for TS 23.501 (Feb. 20-24, 2023). See also 3GPP TSG SA Meeting #SP-98-e, SP-230052 (Mar. 21-24, 2023).

Accordingly, it may be understood that in various embodiments, to provide UEs with complete clock quality information, an NG-RAN uses unicast RRC signaling. This may occur as a matter of course for UEs already in an RRC_CONNECTED state. However, for UE(s) not in the RRC_CONNECTED state (e.g., that are in an RRC_IDLE or RRC_INACTIVE state), it may be that the UE first establishes or resumes (as the case may be) an RRC connection with the NG-RAN such that the UE can receive the clock quality information from the NG-RAN, following an indication of a time synchronization status change in an SIB 9 received at the UE.

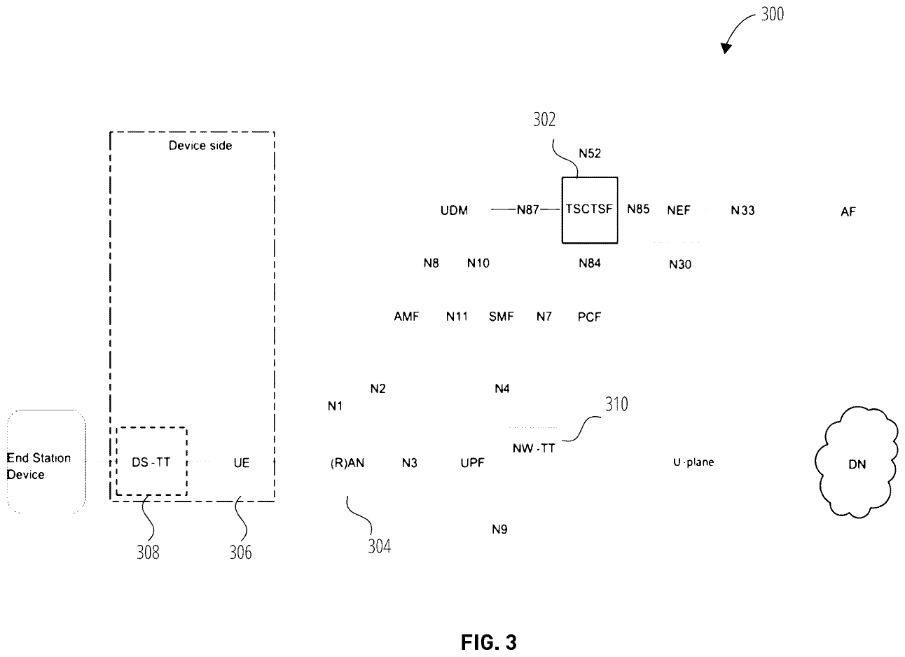

FIG. 3 illustrates a 5GS 300, according to embodiments discussed herein. As illustrated, the 5GS 300 includes, among other things, a TSCTSF 302, a RAN 304, a UE 306, a device side time sensitive networking (TSN) translator (DS-TT) 308, and a network TSN translator (NW-TT) 310.

Multiple types of time synchronization processes may supported by a 5GS. A first supported type of time synchronization process may be a 5GS synchronization. For 5GS synchronization, the access stratum (AS) (via the RAN 304) provides the 5G internal system clock to the UE 306 through the use of base station signaling. Moreover, the UE 306 may forward this 5G internal system clock as received to one or more device side time sensitive networking (TSN) translator(s) (DS-TT(s)) 308. This process may be referred to as access stratum time synchronization (ASTI).

A second supported type of synchronization process may be a (generalized) precision time protocol ((g)PTP) domain synchronization. For (g)PTP domain synchronization, the UE 306 may forward (g)PTP messages to the DS-TT 308 that is associated with a protocol data unit (PDU) session.

In some embodiments, it is considered that the elements illustrated between the DS-TT 308 and the NW-TT 310 (e.g., the 5G system as a whole) make up or act as a TSN bridge with respect to TSN functions utilized by the 5GS 300.

It has been noted that it may not be strictly/inherently necessary that a UE immediately performs a transition to RRC_CONNECTED to retrieve the latest available clock quality information upon receiving an indication that updated clock quality information is available (e.g., in SIB 9, as discussed herein). It has also been noted that in cases with relatively many UEs, simultaneous access attempts by such UEs (e.g., in response to the receipt at each UE of the indication that updated clock quality information is available) may be problematic for network capacity/congestion reasons. Accordingly, in order to reduce the number of UEs simultaneously using random access channel (RACH) access to move back to RRC CONNECTED state to enable the receipt of updated clock quality information, it may be that the RAN causes that the UE(s) randomize their timings for re-connecting back to the network such that these connection attempts are spread in the time domain (e.g., over the course of one minute). See, e.g., 3GPP S2-2301461, TSG-SA2 Meeting #154-AH-e, CR 0002 for TR 23.900-25 (Jan. 16-20, 2023) and 3GPP SP-230066 , TSG SA Meeting #SP-98-e, (Mar. 21-24, 2023).

There may be a number of options for a UE to randomize its UE access for clock quality information retrieval (or for reception of updated time synchronization information, as described in the background slides). Further, in some embodiments the UE may not always have to enter RRC CONNECTED state. Described herein are embodiments that do not always enter RRC_CONNECTED state. Some embodiments may use of small data transmission (SDT) in RRC_INACTIVE state.

SDT is a procedure allowing data and/or signaling transmission while remaining in RRC INACTIVE state (i.e. without transitioning to RRC_CONNECTED state). SDT is enabled on a radio bearer basis and is initiated by the UE if certain conditions are met.

In some cases, an update of time synchronization information (including clock quality information) could be achieved at the UE without the UE first entering into the RRC CONNECTED state. For example, if the UE supports SDT, the network may directly send a DLInformationTransfer message to a UE that is in the RRC_INACTIVE state. The DLInformationTransfer message may contain relevant time synchronization information, such as a referenceTimeInfo IE and/or information about propagation delay compensation (PDC), such as an rxTxTimeDiff-gNB parameter and/or a ta-PDC parameter. Additionally to these objects, a DLInformationTransfer message may be extended with new parameters for clock quality and time synchronization update purposes. Moreover, the DLInformationTransfer message may carry a DedicatedNAS-Message field, which may contain further time synchronization information (e.g., including clock quality information) directly from the CN (e.g., originating from a TSN AF, a TSCTSF, a session management function (SMF), a policy control function (PCF), or an AMF).

Likewise, a UE in an RRC_INACTIVE state may initiate, during SDT, a UL information transfer procedure (using a ULInformationTransfer message and/or a DedicatedNAS-Message field), for example, when there is a need to transfer NAS dedicated information related to time synchronization to the CN. Such a transaction may be triggered by higher layers.

Some embodiments define initial procedure details with regards to time synchronization updates in RRC_INACTIVE state. In some embodiments, the UE may detect a condition to obtain updated clock quality information (e.g., through a time synchronization status change, the indication of a time service quality degradation, or the indicated availability of a configuration update). In some embodiments, such indication may happen via SIB 9 broadcast signaling as part of a time synchronization status change. In some embodiments, the network may indicate the availability of updated clock quality information and time synchronization information via UE dedicated signaling.

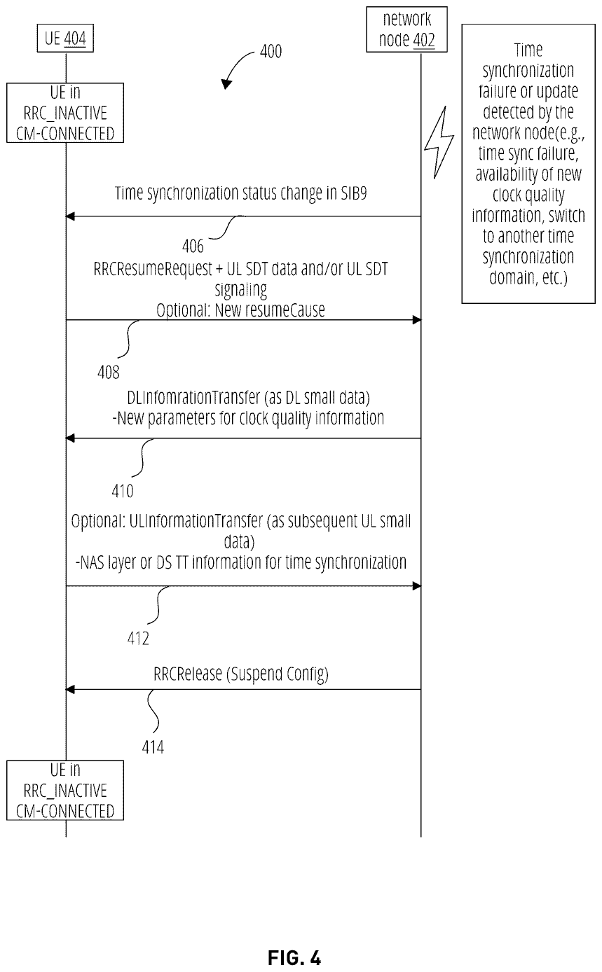

FIG. 4 illustrates a signal flow diagram 400 of a mobile originated (MO) random access (RA) SDT for an update for time synchronization in accordance with some embodiments. An update for time synchronization (or clock quality information retrieval) may utilize the RRC_INACTIVE state. In some cases, the UE 404 is in RRC INACTIVE/CM-CONNECTED and does not have an ongoing SDT session when a (relevant) SIB 9 update is detected.

For example, in the illustrated embodiment the network node 402 detects a time synchronization failure or update. For instance, the network node 402 may detect availability of new clock quality information, a switch to another time synchronization domain, etc. Due to the time synchronization failure or update, the network node 402 sends a SIB 406. The SIB 406 may be a SIB 9 and may include a time synchronization status change. The UE 404 may detect the SIB 406.

If the UE 404 can use SDT and the conditions to initiate SDT transfer are fulfilled the UE 306 initiates a SDT session based on the SDT resources available/configured. The conditions to initiate the SDT transfer may be defined in the current specification, and may include that there is no data available for non-SDT radio bearers, the available amount of uplink (UL) data is less than a threshold, SDT is enabled for the resource block (RB), etc.

The SDT session may be RA-SDT or configured grant (CG) SDT.

If the SDT session is a MO-SDT, where the trigger is because of the SIB indication (e.g., SIB 406) for the need of a time sync update, then the UE 404 can initiate RACH (for RA-SDT), or the UE 404 can skip RACH and use CG-SDT (if possible). Both of these SDT sessions may be based on Non-access stratum (NAS) triggers or Radio Resource Control (RRC) triggers. The UE 404 access attempt randomization may happen, for example, in RRC or NAS.

To initiate the RA-SDT session, the UE 404 may send an RRCResumeRequest 408. In some embodiments, the RRCResumeRequest 408 may include a new resumeCause value to indicate the type of request. In some embodiments, clock quality information retrieval may use a separate Access Category or a special mapping of a new Access Identity to an Access Category, although the latter may also show as a new resumeCause value in the RRCResumeRequest or RRCResumeRequest1 message. In some embodiments, the RRCResumeRequest 408 may include UL SDT data and/or UL SDT signaling.

The network node 402 may generate and send DLInformation Transfer 410 to the UE 404. The DLInformation Transfer 410 may be sent as downlink (DL) small data. The DLInformation Transfer 410 may include new parameters for clock quality information.

In some embodiments, subsequent UL small data (e.g., ULInformationTransfer 412) may include NAS layer or DS-TT information for time synchronization. The network node 402 may send an RRCRelease 414 to the UE 404 to suspend the configuration and the UE 404 may remain in a RRC_INACTIVE state.

For CG-SDT, the UE 404 may include in ULInformationTransfer 412 a request to retrieve clock quality information. Uplink related time synchronization information can also be provided by the NAS layer or the DS-TT via DedicatedNAS-Message. Further, in some embodiments the UE 404 may send RRCResumeRequest or RRCResumeRequest1 over Dedicated Control Channel (DCCH). The RRCResumeRequest or RRCResumeRequest1 over DCCH may include the new resumeCause value to indicate the type of request.

Once the SDT session is ongoing, it may be possible to have subsequent UL or DL small data in the same SDT session. The UE 404 may not need to enter RRC_CONNECTED mode in order for the clock quality information update to be retrieved.

In some instances, the UE 404 may be in a RRC_INACTIVE state with an ongoing SDT session. An update for time synchronization or clock quality information retrieval may utilize the RRC_INACTIVE state. For example, when the UE 404 is in a RRC_INACTIVE state and CM-CONNECTED state, and the UE 404 has an ongoing SDT session when the need for time synchronization update arises (e.g., detected via SIB9), the UE 404 and network node 402 may use the ongoing SDT session.

The network may directly send updated time synchronization information via DLInformationTransfer (including new clock quality parameters) or a DedicatedNAS-Message (with new clock quality information) from the core network (CN). Furthermore, it is possible to have subsequent UL or DL small data in the same SDT session. In other words, the clock information update may happen in RRC_INACTIVE, unless the network sends the UE to RRC_CONNECTED as part of the SDT procedure.

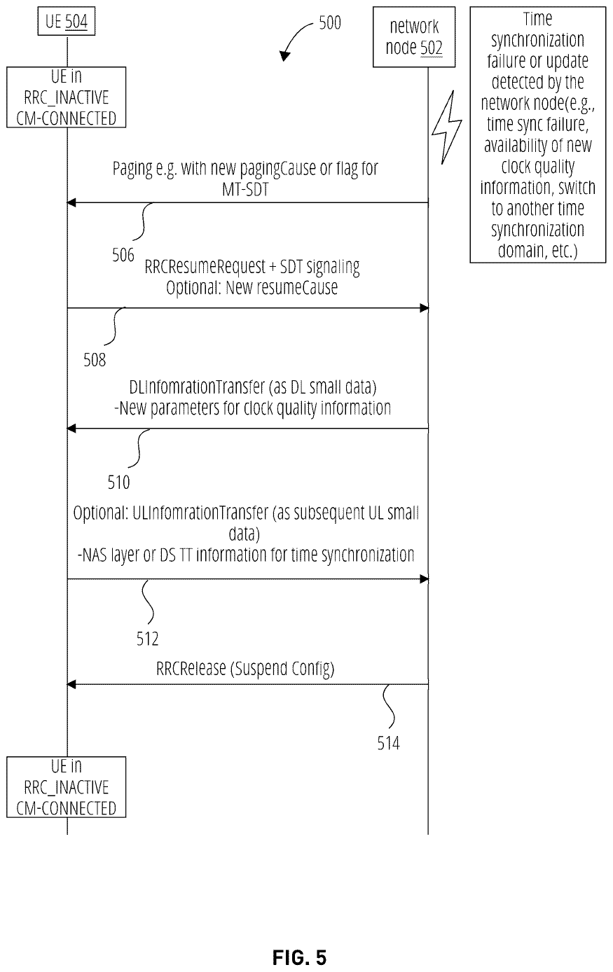

FIG. 5 illustrates a signal flow diagram 500 of a mobile terminated (MT) RA-SDT for an update for time synchronization in accordance with some embodiments. An update for time synchronization (or clock quality information retrieval) may utilize the RRC_INACTIVE state without ongoing SDT session using MT-SDT.

In some embodiments, if the UE is not in an active SDT session, alternatively or additionally the network may use mobile terminated SDT (MT-SDT) to initiate a SDT session. Use of MT-SDT may be an alternative to embodiments that use MO-SDT or combined with embodiments that use MO-SDT.

In the illustrated embodiment, the UE 504 is in RRC_INACTIVE and/or CM-CONNECTED state. The network node 502 detects a time synchronization failure or update. For instance, the network node 502 may detect availability of new clock quality information, a switch to another time synchronization domain, etc. Due to the time synchronization failure or update, the network node 502 may send a page 506 to the UE 504. The page 506 may be for the purpose of clock quality information retrieval and time synchronization updating.

In some embodiments, for MT-SDT, the network node 502 can directly page the UE 504 with a new pagingCause or another new identifier related to clock quality information retrieval and time synchronization. For example, the page 506 may include the new pagingCause or a flag for MT-SDT. The pagingCause may be an information element that indicates the reason for sending the paging message. The new pagingCause may be associated with MT-SDT and included in a PagingRecord, a new accessType, etc.

The UE 504 may send an RRCResumeRequest 508. In some embodiments, the RRCResumeRequest 508 may include a new resumeCause value to indicate the type of request. In some embodiments, clock quality information retrieval may use a separate Access Category or a special mapping of a new Access Identity to an Access Category, although the latter may also show as a new resumeCause value in the RRCResumeRequest or RRCResumeRequest1 message. In some embodiments, the RRCResumeRequest 508 may include UL SDT data and/or UL SDT signaling.

The network node 502 may generate and send DLInformation Transfer 510 to the UE 504. The DLInformation Transfer 510 may be sent as downlink (DL) small data. The DLInformation Transfer 510 may include new parameters for clock quality information.

In some embodiments, subsequent UL small data (e.g., ULInformationTransfer 512) may include NAS layer or DS-TT information for time synchronization. The network node 502 may send an RRCRelease 514 to the UE 504 to suspend the configuration and the UE 504 may remain in a RRC_INACTIVE state.

In some embodiments, normal MT-SDT procedures may be used (without new paging identifiers) to trigger the exchange of clock quality information. The network nodes 502 may provide updates via DL message. For example, the network node 502 may provide updates in the DLInformationTransfer 510 (including new clock quality parameters) or a DedicatedNAS-Message.

In some embodiments, paging may be used to for clock quality information retrieval and time synchronization. Paging may allow the network node 502 to reach the UE 504 in RRC IDLE and in RRC_INACTIVE states through paging messages, and may notify UE 504 in RRC_IDLE, RRC_INACTIVE and RRC_CONNECTED states of system information changes.

Having the ability to page UEs for the purpose of clock quality information retrieval and time synchronization provides the network node 502 with the option not to page all of the UEs at the same time. Note that such paging may also be used independently of MT-SDT. The network node 502 may manage the paging to avoid network overload. In some embodiments, optimizations for time synchronization may be desired. The following options may be implemented by embodiments herein.

In some embodiments, the network node 502 may directly page the UE 504 with a new pagingCause or another new identifier related to clock quality information retrieval and time synchronization included in a PagingRecord, a new accessType, etc.

In some embodiments, CN-initiated paging (RRC_IDLE or RRC_INACTIVE) may be implemented. As per Access Category and Unified Access control procedures, the UE 504 may initiate RRCSetupRequest with appropriate (new) establishment cause indicating the clock quality information. Alternatively, CN paging may happen with a new 5G-S-TMSI type dedicated to time synchronization. When the UE 504 receives the 5G-S-TMSI type dedicated to time synchronization, it may react accordingly to retrieve the updated clock quality information.

In some embodiments, RAN-initiated paging (RRC_INACTIVE) paging may be implemented. To identify a request for a clock quality information and time synchronization update, the RAN paging may occur with a new RNTI associated with this purpose.

In some embodiments, when the UE 504 identifies a paging for the purpose of clock quality and time synchronization, the UE 504 may choose to ignore the paging. For example, if the updated clock quality information is not urgently needed according to the UE's DS-TT's internal state the UE 504 may ignore the paging. In this case, the UE 504 may choose to connect to trigger an access request at a later time.

Unless paging can be done based on time synchronization domains (which is one option), the RAN paging area provided by a serving NG-RAN node (e.g., network node 502) may match with the area scope for time synchronization. For example, the area scope for time synchronization may be a group of cells within a single network node (e.g., gNB) or a group of cells across multiple network nodes (e.g., gNBs). One option to achieve this may be to configure RAN-based notification areas (RNAs) accordingly. That is, network nodes with support for timing resiliency are associated by network configuration with an appropriate RAN paging area (e.g., a group of cells within a single gNB or a group of cells across gNBs) or RNA (based on a list of cells or RAN Area ID(s), where RAI=TAC+RANAC). For CN-initiated paging, which may cover a larger area (e.g, it may be based on Registration Area Code), the NG-RAN may provide the AMF with a list of recommended cells and NG-RAN nodes as assistance info on paging area scope.

In some embodiments, if the UE 504 receives a paging from a network node associated with a different (unaffected) time synchronization domain, the UE 504 may ignore the paging. For example, if the UE 504 determines that a network node with a different timing domain sent a page, the UE 504 may ignore it. Furthermore, extensions for paging may also impact RAN3 interfaces.

Additionally, for both MO-SDT and MT-SDT (e.g., FIG. 4 and FIG. 5), there may be additional options for the UE dedicated time synchronization updates. These additional options may have relevance to a RRC_INACTIVE, as well as a UE in RRC_CONNECTED.

If a (relevant) SIB9 change (or another trigger for clock quality information retrieval) is detected, the UE may use ULInformation Transfer (via SDT) to request updated clock quality information from the network. To request updated clock quality information, the UE may provide the latest reference report ID (e.g., reference report ID included in the SIB9) as a parameter, the latest event ID (e.g., reference report ID included in the SIB9) as a parameter, or by setting a flag In a new field of the ULInformationTransfer message. This option may be used in the RRC_CONNECTED mode as well as RRC_INACTIVE. By using such new fields in the ULInformationTransfer, the ULInformationTransfer is not triggered by the NAS but rather by the Access Stratum directly.

In some embodiments, in cases with an ongoing SDT session, the UE time synchronization update may be considered as a UE dedicated update. This may be somewhat similar to a UE that is in RRC_CONNECTED, where the network provides dedicated information to the UE directly. In these cases (both for RRC_CONNECTED and RRC_INACTIVE), the UE can identify whether the clock quality information relates to the latest update on SIB9. Therefore, the dedicated information (provided by the network via RRC unicast) may contain a linking or an association to the reference report ID in SIB9 in a parameter (including the scope of the report ID and an Event ID). If the UE identifies (e.g., by examining the reference report ID) that the dedicated information does not refer the latest clock quality information update it may disregard the information. Likewise, if the UE identifies a new SIB9 update after the current clock information retrieval has ended, the UE may consider a new transaction according to one of embodiments herein.

The embodiments herein may be applied by a UE and network jointly (combined) or applied separately.

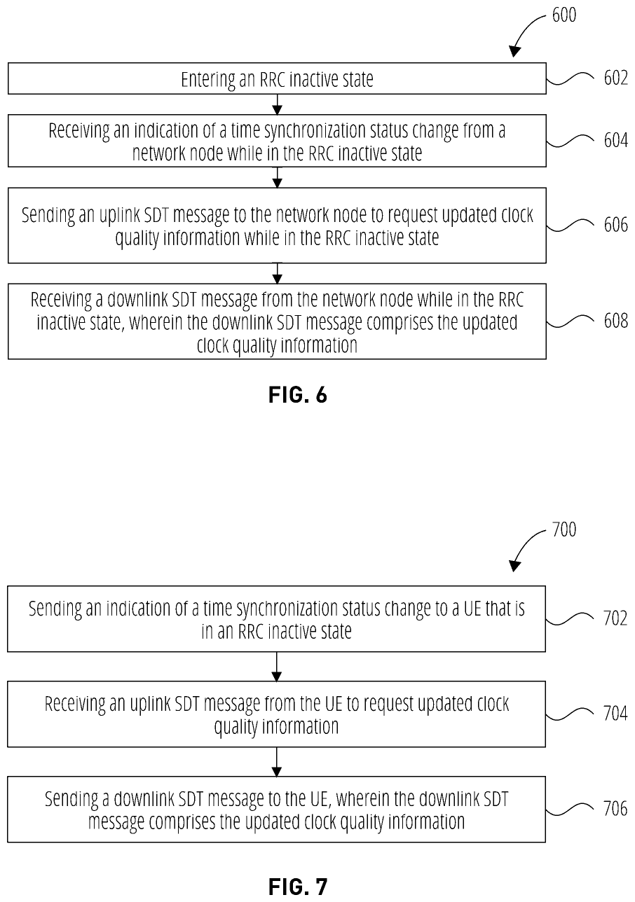

FIG. 6 illustrates a flowchart of a method 600 of a UE, according to embodiments herein. The method 600 includes entering 602 an RRC inactive state.

The method 600 further includes receiving 604 an indication of a time synchronization status change from a network node while in the RRC inactive state.

The method 600 further includes sending 606 an uplink SDT message to the network node to request updated clock quality information while in the RRC inactive state.

The method 600 further includes receiving 608 a downlink SDT message from the network node while in the RRC inactive state, wherein the downlink SDT message comprises the updated clock quality information.

In some embodiments of the method 600, the indication of the time synchronization status change comprises a paging message from the network node. In some such embodiments, the paging message comprises a paging cause or identifier associated with clock quality information retrieval and time synchronization.

In some embodiments of the method 600, the indication of the time synchronization status change comprises a system information block.

In some embodiments of the method 600, the uplink SDT message comprises a RRC resume request comprising a resume cause value associated with clock quality information retrieval and time synchronization In some embodiments of the method 600, the uplink SDT message comprises an uplink information transfer message including a request to retrieve the updated clock quality information.

In some embodiments of the method 600, when the UE has an ongoing SDT session with the network node when a time synchronization update arise, the updated clock quality information is received via a downlink information transfer message or a dedicated non-access stratum message.

Embodiments contemplated herein include an apparatus comprising means to perform one or more elements of the method 600. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a UE (such as a memory 906 of a wireless device 902 that is a UE, as described herein).

Embodiments contemplated herein include an apparatus comprising logic, modules, or circuitry to perform one or more elements of the method 600. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a UE (such as a wireless device 902 that is a UE, as described herein).

Embodiments contemplated herein include a signal as described in or related to one or more elements of the method 600.

Embodiments contemplated herein include a computer program or computer program product comprising instructions, wherein execution of the program by a processor is to cause the processor to carry out one or more elements of the method 600. The processor may be a processor of a UE (such as a processor(s) 904 of a wireless device 902 that is a UE, as described herein). These instructions may be, for example, located in the processor and/or on a memory of the UE (such as a memory 906 of a wireless device 902 that is a UE, as described herein).

FIG. 7 illustrates a flowchart of a method 700 of a network node, according to embodiments herein. The method 700 includes sending 702 an indication of a time synchronization status change to a UE that is in an RRC inactive state.

The method 700 further includes receiving 704 an uplink SDT message from the UE to request updated clock quality information

The method 700 further includes sending 706 a downlink SDT message to the UE, wherein the downlink SDT message comprises the updated clock quality information.

In some embodiments of the method 700, the indication of the time synchronization status change comprises a paging message from the network node. In some such embodiments, the paging message comprises a paging cause or identifier associated with clock quality information retrieval and time synchronization.

In some embodiments of the method 700, the indication of the time synchronization status change comprises a system information block.

In some embodiments of the method 700, the uplink SDT message comprises a RRC resume request comprising a resume cause value associated with clock quality information retrieval and time synchronization

In some embodiments of the method 700, the uplink SDT message comprises an uplink information transfer message including a request to retrieve the updated clock quality information.

In some embodiments of the method 700, when the UE has an ongoing SDT session with the network node when a time synchronization update arise, the updated clock quality information is received via a downlink information transfer message or a dedicated non-access stratum message.

Embodiments contemplated herein include an apparatus comprising means to perform one or more elements of the method 700. This apparatus may be, for example, an apparatus of a base station (such as a network device 918 that is a base station, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a base station (such as a memory 922 of a network device 918 that is a base station, as described herein).

Embodiments contemplated herein include an apparatus comprising logic, modules, or circuitry to perform one or more elements of the method 700. This apparatus may be, for example, an apparatus of a base station (such as a network device 918 that is a base station, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a base station (such as a network device 918 that is a base station, as described herein).

Embodiments contemplated herein include a signal as described in or related to one or more elements of the method 700.

Embodiments contemplated herein include a computer program or computer program product comprising instructions, wherein execution of the program by a processing element is to cause the processing element to carry out one or more elements of the method 700. The processor may be a processor of a base station (such as a processor(s) 920 of a network device 918 that is a base station, as described herein). These instructions may be, for example, located in the processor and/or on a memory of the base station (such as a memory 922 of a network device 918 that is a base station, as described herein).

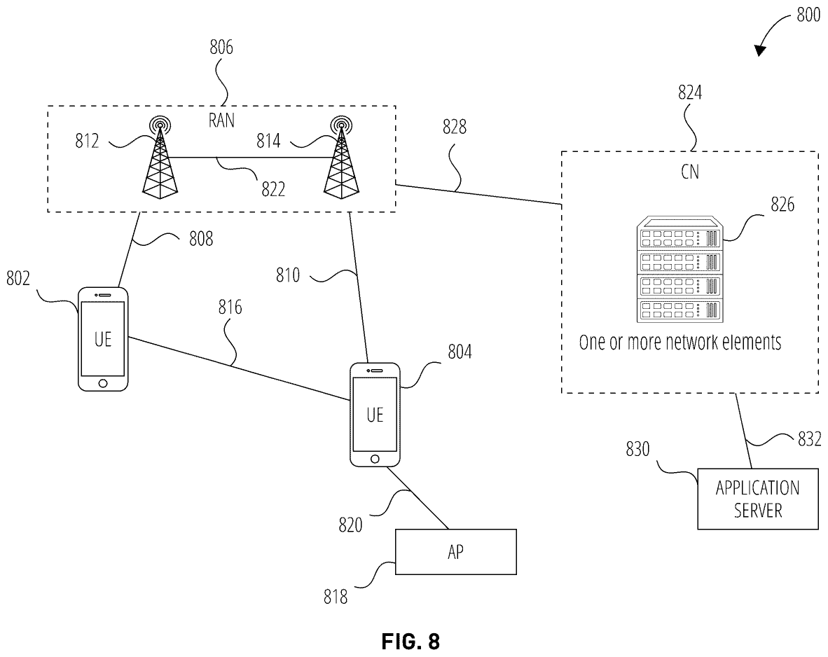

FIG. 8 illustrates an example architecture of a wireless communication system 800, according to embodiments disclosed herein. The following description is provided for an example wireless communication system 800 that operates in conjunction with the LTE system standards and/or 5G or NR system standards as provided by 3GPP technical specifications.

As shown by FIG. 8, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks), but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more base stations (such as base station 812 and base station 814) that enable the connection 808 and connection 810.

In this example, the connection 808 and connection 810 are air interfaces to enable such communicative coupling, and may be consistent with RAT(s) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi® router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other or with the base station 812 and/or the base station 814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more base stations (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more base stations (e.g., two or more gNBs and the like) that connect to 5GC, between a base station 812 (e.g., a gNB) connecting to 5GC and an eNB, and/or between two eNBs connecting to 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In embodiments, the CN 824 may be an EPC, and the RAN 806 may be connected with the CN 824 via an S1 interface 828. In embodiments, the S1 interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the base station 812 or base station 814 and a user plane function (UPF), and the SI control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VoIP sessions, group communication sessions, etc.) for the UE 802 and UE 804 via the CN 824. The application server 830 may communicate with the CN 824 through an IP communications interface 832.

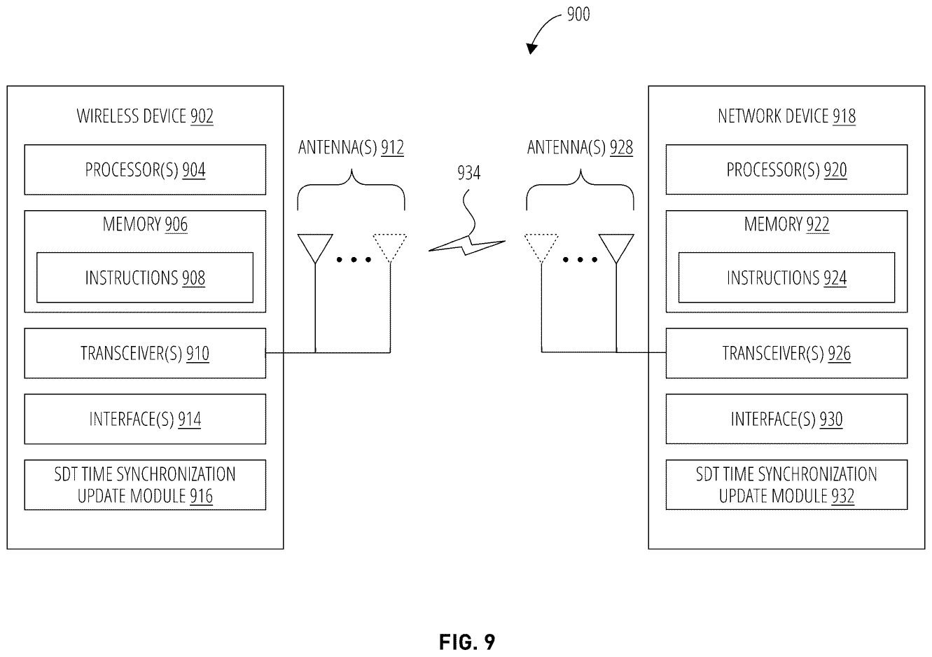

FIG. 9 illustrates a system 900 for performing signaling 934 between a wireless device 902 and a network device 918, according to embodiments disclosed herein. The system 900 may be a portion of a wireless communications system as herein described. The wireless device 902 may be, for example, a UE of a wireless communication system. The network device 918 may be, for example, a base station (e.g., an eNB or a gNB) of a wireless communication system.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 that may include radio frequency (RF) transmitter circuitry and/or receiver circuitry that use the antenna(s) 912 of the wireless device 902 to facilitate signaling (e.g., the signaling 934) to and/or from the wireless device 902 with other devices (e.g., the network device 918) according to corresponding RATs.

The wireless device 902 may include one or more antenna(s) 912 (e.g., one, two, four, or more). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth®, and the like).

The wireless device 902 may include an SDT time synchronization update module 916. The SDT time synchronization update module 916 may be implemented via hardware, software, or combinations thereof. For example, the SDT time synchronization update module 916 may be implemented as a processor, circuit, and/or instructions 908 stored in the memory 906 and executed by the processor(s) 904. In some examples, the SDT time synchronization update module 916 may be integrated within the processor(s) 904 and/or the transceiver(s) 910. For example, the SDT time synchronization update module 916 may be implemented by a combination of software components (e.g., executed by a DSP or a general processor) and hardware components (e.g., logic gates and circuitry) within the processor(s) 904 or the transceiver(s) 910.

The SDT time synchronization update module 916 may be used for various aspects of the present disclosure, for example, aspects of FIGS. 1-7. The SDT time synchronization update module 916 is configured to facilitate time synchronization updates when the wireless device 902 is in RRC_INACTIVE state.

The network device 918 may include one or more processor(s) 920. The processor(s) 920 may execute instructions such that various operations of the network device 918 are performed, as described herein. The processor(s) 920 may include one or more baseband processors implemented using, for example, a CPU, a DSP, an ASIC, a controller, an FPGA device, another hardware device, a firmware device, or any combination thereof configured to perform the operations described herein.

The network device 918 may include a memory 922. The memory 922 may be a non-transitory computer-readable storage medium that stores instructions 924 (which may include, for example, the instructions being executed by the processor(s) 920). The instructions 924 may also be referred to as program code or a computer program. The memory 922 may also store data used by, and results computed by, the processor(s) 920.

The network device 918 may include one or more transceiver(s) 926 that may include RF transmitter circuitry and/or receiver circuitry that use the antenna(s) 928 of the network device 918 to facilitate signaling (e.g., the signaling 934) to and/or from the network device 918 with other devices (e.g., the wireless device 902) according to corresponding RATs.

The network device 918 may include one or more antenna(s) 928 (e.g., one, two, four, or more). In embodiments having multiple antenna(s) 928, the network device 918 may perform MIMO, digital beamforming, analog beamforming, beam steering, etc., as has been described.

The network device 918 may include one or more interface(s) 930. The interface(s) 930 may be used to provide input to or output from the network device 918. For example, a network device 918 that is a base station may include interface(s) 930 made up of transmitters, receivers, and other circuitry (e.g., other than the transceiver(s) 926/antenna(s) 928 already described) that enables the base station to communicate with other equipment in a core network, and/or that enables the base station to communicate with external networks, computers, databases, and the like for purposes of operations, administration, and maintenance of the base station or other equipment operably connected thereto.

The network device 918 may include an SDT time synchronization update module 932. The SDT time synchronization update module 932 may be implemented via hardware, software, or combinations thereof. For example, the SDT time synchronization update module 932 may be implemented as a processor, circuit, and/or instructions 924 stored in the memory 922 and executed by the processor(s) 920. In some examples, the SDT time synchronization update module 932 may be integrated within the processor(s) 920 and/or the transceiver(s) 926. For example, the SDT time synchronization update module 932 may be implemented by a combination of software components (e.g., executed by a DSP or a general processor) and hardware components (e.g., logic gates and circuitry) within the processor(s) 920 or the transceiver(s) 926.

The SDT time synchronization update module 932 may be used for various aspects of the present disclosure, for example, aspects of FIGS. 1-7. The SDT time synchronization update module 932 is configured to facilitate time synchronization updates when the wireless device 902 is in RRC_INACTIVE state.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
entering a radio resource control (RRC) inactive state;
receiving an indication of a time synchronization status change from a network node while in the RRC inactive state; and
receiving a downlink small data transmission (SDT) message from the network node while in the RRC inactive state, wherein the downlink SDT message comprises the updated clock quality information.

2. The method of claim 1, wherein the indication of the time synchronization status change comprises a paging message from the network node.

3. The method of claim 2, wherein the paging message comprises a paging cause or identifier associated with clock quality information retrieval and time synchronization.

4. The method of claim 1, wherein the indication of the time synchronization status change comprises a parameter in a system information block.

5. The method of claim 1, further comprising sending an uplink SDT message to the network node to request updated clock quality information while in the RRC inactive state.

6. The method of claim 5, wherein the uplink SDT message comprises a RRC resume request comprising a resume cause value associated with clock quality information retrieval and time synchronization.

7. The method of claim 5, wherein the uplink SDT message comprises an uplink information transfer message including a request to retrieve the updated clock quality information.

8. The method of claim 5, wherein the uplink SDT message is sent in subsequent small data of an SDT session.

9. The method of claim 1, wherein the downlink SDT message is received in subsequent small data of an SDT session.

10. The method of claim 1, wherein when the UE has an ongoing SDT session with the network node when a time synchronization update arises, the updated clock quality information is received via a downlink information transfer message or a dedicated non-access stratum message.

11. An apparatus of a user equipment (UE), comprising:
a processor; and
a memory storing instructions that, when executed by the processor, configure the UE to:
enter a radio resource control (RRC) inactive state;
receive an indication of a time synchronization status change from a network node while in the RRC inactive state; and
receive a downlink small data transmission (SDT) message from the network node while in the RRC inactive state, wherein the downlink SDT message comprises the updated clock quality information.

12. The apparatus of claim 11, wherein the indication of the time synchronization status change comprises a paging message from the network node.

13. The apparatus of claim 12, wherein the paging message comprises a paging cause or identifier associated with clock quality information retrieval and time synchronization.

14. The apparatus of claim 11, wherein the indication of the time synchronization status change comprises a parameter in a system information block.

15. The apparatus of claim 14, wherein the instructions stored in memory further configure the UE to send an uplink SDT message to the network node to request updated clock quality information while in the RRC inactive state.

16. The apparatus of claim 14, wherein the uplink SDT message comprises a RRC resume request comprising a resume cause value associated with clock quality information retrieval and time synchronization.

17. The apparatus of claim 11, wherein the uplink SDT message comprises an uplink information transfer message include a request to retrieve the updated clock quality information.

18. The apparatus of claim 11, wherein when the UE has an ongoing SDT session with the network node when a time synchronization update arises, the updated clock quality information is received via a downlink information transfer message or a dedicated non-access stratum message.

19. A method of a network node, comprising:
sending an indication of a time synchronization status change to a user equipment (UE) that is in a radio resource control (RRC) inactive state or RRC idle state;
receiving an uplink small data transmission (SDT) message from the UE to request updated clock quality information; and
sending a downlink SDT message to the UE, wherein the downlink SDT message comprises the updated clock quality information.

20. The method of claim 19, wherein the indication of the time synchronization status change comprises a paging message from the network node.

21-28. (canceled)
